(19) United States
(12) Patent Application Publication
(10) Pub. No.: US 2023/0034027 A1
(43) Pub. Date: Feb. 2, 2023

(54) TRAINING DATA COLLECTION SYSTEM, SIMILARITY SCORE CALCULATION SYSTEM, SIMILAR DOCUMENT RETRIEVAL SYSTEM, AND NON-TRANSITORY COMPUTER READABLE RECORDING MEDIUM STORING TRAINING DATA COLLECTION PROGRAM

(71) Applicant: KYOCERA Document Solutions Inc., Osaka-shi (JP)

(72) Inventors: Koji SATO, Osaka-shi (JP); Kanako MORIMOTO, Osaka-shi (JP); Rui HAMABE, Osaka-shi (JP); kazunori TANAKA, Osaka-shi (JP); Takuya MIYAMOTO, Osaka-shi (JP)

(21) Appl. No.: 17/873,371

(22) Filed: Jul. 26, 2022

(30) Foreign Application Priority Data
Jul. 29, 2021 (JP) 2021-123803

(51) Int. Cl. G06K 9/62; G06F 16/33

(52) U.S. Cl. CPC G06K 9/6256; G06F 16/3347; G06K 9/6215

(57) ABSTRACT

A vector generation unit derives a feature vector of a reference document and a feature vector of a population document. A feature quantity extraction unit performs a dimensionality reduction process to reduce dimensionality of the above feature vectors and sets a dimensional value obtained by the dimensionality reduction process as a first feature quantity, and derives a cosine similarity between the feature vector of the reference document and the feature vector of the population document as a second feature quantity. A retrieval range control unit extracts a specific number of population documents, starting from the population document with the shortest distance to the reference document in a feature quantity space of the first feature quantity, so as to limit a retrieval range. A training data extraction unit extracts, as training data, a specific number of documents from the extracted documents, starting from the document with the lowest cosine similarity.

### INCORPORATION BY REFERENCE

This application is based upon, and claims the benefit of priority from, corresponding Japanese Patent Application No. 2021-123803 filed in the Japan Patent Office on Jul. 29, 2021, the entire contents of which are incorporated herein by reference.

### BACKGROUND

### Field of the Invention

The present disclosure relates to a training data collection system, a similarity score calculation system, a similar document retrieval system, and a non-transitory computer readable recording medium storing a training data collection program.

### Description of Related Art

Some document processing device derives a document vector of a target document, and derives a cosine value (cosine similarity) of the document vector as an indicator of similarity between documents.

During the collection of documents in a certain field as training data for machine learning, some training data collection device (a) derives feature vectors based on the number of occurrences of a word in reference data and collected data, respectively, (b) derives a cosine similarity between the feature vector of the reference data and the feature vector of the collected data, and (c) extracts, from pieces of collected data, a piece of collected data with a cosine similarity falling within a specific range as training data.

### SUMMARY

A training data collection system according to the present disclosure includes a vector generation unit, a feature quantity extraction unit, a retrieval range control unit, and a training data extraction unit. The vector generation unit derives a feature vector of a reference document, and derives a feature vector of each document belonging to a population. The feature quantity extraction unit (a) performs a dimensionality reduction process to reduce dimensionality of the feature vector of the reference document and the feature vector of each document belonging to the population and sets a dimensional value obtained by the dimensionality reduction process performed on the feature vector of the reference document and the feature vector of each document belonging to the population as a first feature quantity and (b) derives a cosine similarity between the feature vector of the reference document and the feature vector of each document belonging to the population as a second feature quantity. The retrieval range control unit extracts a specific number of documents from the population in ascending order of a distance from a document belonging to the population to the reference document in a feature quantity space of the first feature quantity, starting from a document with a shortest distance to the reference document, so as to limit a retrieval range. The training data extraction unit extracts, as training data, a specific number of documents from among the specific number of documents, which have been extracted by the retrieval range control unit, in ascending order of the cosine similarity, starting from a document with a lowest cosine similarity.

A similarity score calculation system according to the present disclosure includes the training data collection system as above, a similarity score calculation unit that calculates a similarity score of a document of the training data, and a machine learning processing unit that uses the training data to implement machine learning of the similarity score calculation unit.

A similar document retrieval system according to the present disclosure includes the similarity score calculation system as above, a retrieval condition input unit that designates the reference document, and a similarity score display unit that sorts documents extracted as the training data, in descending order of the similarity score and displays a combination of the documents and similarity scores of the documents.

In a non-transitory computer readable recording medium storing a training data collection program according to the present disclosure, the training data collection program causes a computer to serve as the vector generation unit, the feature quantity extraction unit, the retrieval range control unit, and the training data extraction unit, which are each described above.

The above and other objects, features, and advantages of the present disclosure will be more evident from the detailed description below as well as the accompanying drawings.

### BRIEF DESCRIPTION OF THE DRAWINGS

FIG. 1 is a block diagram illustrating a configuration of a similar document retrieval system according to an embodiment of the present disclosure; and

FIG. 2 is a diagram illustrating an example of a population, a reference document, and a retrieval range in a feature quantity space.

### DETAILED DESCRIPTION

In the following, an embodiment of the present disclosure is described based on the drawings.

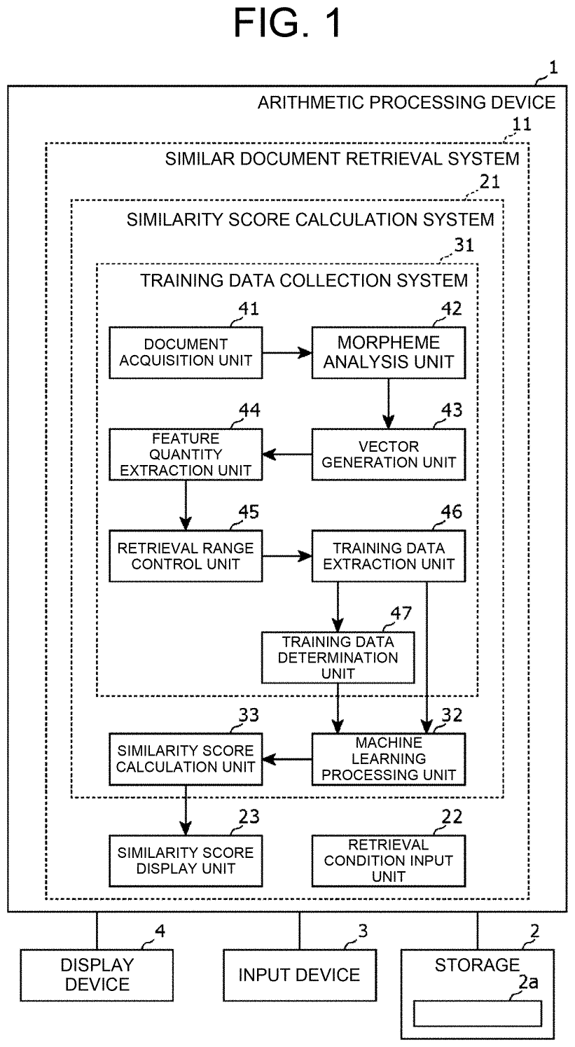

FIG. 1 is a block diagram illustrating a configuration of a similar document retrieval system according to the embodiment of the present disclosure. The similar document retrieval system illustrated in FIG. 1 includes an arithmetic processing device 1 as a computer, a nonvolatile storage 2, an input device 3 to detect a user operation, and a display device 4 to display various kinds of information toward a user.

The arithmetic processing device 1 includes a central processing unit (CPU), a read-only memory (ROM), and a random access memory (RAM), loads programs stored in the ROM and the storage 2 into the RAM, and executes the programs with the CPU so as to serve as various processing units.

The arithmetic processing device 1 executes a similar document retrieval program 2a in the storage 2 so as to serve as a similar document retrieval system 11.

The similar document retrieval system 11 includes a similarity score calculation system 21, a retrieval condition input unit 22, and a similarity score display unit 23.

The similarity score calculation system 21 includes a training data collection system 31, a machine learning processing unit 32, and a similarity score calculation unit 33.

The training data collection system 31 includes a document acquisition unit 41, a morpheme analysis unit 42, a vector generation unit 43, a feature quantity extraction unit 44, a retrieval range control unit 45, a training data extraction unit 46, and a training data determination unit 47.

The document acquisition unit 41 acquires a reference document (document data) designated by the user and a document (document data) belonging to a population. The reference document is excluded from the population. The document acquisition unit 41 may use a communications device not illustrated to access a server on a network so as to acquire such documents or may read such documents previously stored in the storage 2.

The morpheme analysis unit 42 extracts a morpheme of the reference document and a morpheme of each document belonging to the population with a known technique. Apart or parts of speech designated in advance (namely, nouns only, nouns and adjectives or the like) are designated as a morpheme.

The vector generation unit 43 uses a known technique to derive a feature vector of the reference document and a feature vector of each document belonging to the population (hereinafter referred to as “population document”). For instance, the vector generation unit 43 generates a feature vector of a morpheme in a document, and generates a feature vector of the document from the feature vector of the morpheme in the document.

Feature vectors are derived by a count-based technique (such as a term frequency-inverse document frequency (TF-IDF) method) or a distributed representation technique (such as Word2vec and Bidirectional Encoder Representations from Transformers (BERT)), for instance. In the case of the count-based technique, a feature vector (of a document) is generated based on the number of occurrences of a word, while, in the distributed representation technique, the sum total or the mean value of feature vectors of words in a document is derived as a feature vector (of the document).

The feature quantity extraction unit 44 (a) performs a dimensionality reduction process to reduce dimensionality of the above feature vectors (the feature vector of the reference document and the feature vector of the population document) and sets a value of one or more dimensions obtained by the dimensionality reduction process performed on the feature vectors and (b) derives a cosine similarity between the feature vector of the reference document and the feature vector of the population document as a second feature quantity.

The dimensionality reduction process is carried out by principal component analysis (PCA), singular value decomposition (SVD) or t-distributed stochastic neighbor embedding (t-SNE), for instance.

Values of the first feature quantity and the second feature quantity for the population document are associated with the population document and as such stored in the storage 2, for instance, and read by the retrieval range control unit 45, the training data extraction unit 46, and the like as required.

The retrieval range control unit 45 extracts a specific number (the number of documents making up 10% of the population, for instance) of documents from the population in ascending order of the distance from a population document to the reference document in a feature quantity space (space based on dimensions left after the dimensionality reduction process, namely, two-dimensional principal component space constituted of two principal components, for instance) of the first feature quantity, starting from the document with the shortest distance to the reference document, so as to limit a retrieval range. In other words, the extracted documents are assumed to constitute the retrieval range (of the training data extraction unit 46) and the documents, which were not extracted, are excluded from the retrieval range (of the training data extraction unit 46).

The training data extraction unit 46 extracts, as training data, a specific number of documents from among the documents, which have been extracted by the retrieval range control unit 45, in ascending order of the cosine similarity as the second feature quantity, starting from the document with the lowest cosine similarity. In other words, a document with a low similarity in a population surrounding the reference document in the feature quantity space as above is assumed to be training data as a non-related document. To be more precise, the similarity score (relatedness) corresponding to the document is made zero (non-related), and the document is added to the training data as a document (input data) with a similarity score (output data) of zero.

The training data determination unit 47 allows the user to determine, for each document extracted by the training data extraction unit 46 as training data, whether the relevant document is a non-related document, so as to acquire the result of determination by the user (that the relevant document is a non-related document or that the relevant document is a related document). The training data determination unit 47 then performs annotation, gives each document extracted as training data a similarity score depending on whether the relevant document is a non-related document, and associates the similarity score with the relevant document so as to include the similarity score into the training data. For instance, the training data determination unit 47 displays, on the display device 4, a list of documents extracted by the training data extraction unit 46 as training data and specifies, for each document on the list, whether the relevant document is a non-related document, based on the user operation detected through the input device 3, so as to acquire the result of determination by the user. The similarity score corresponding to the relevant document is set to a value (0 or 1, for instance) corresponding to the result of the determination (that the relevant document is a non-related document or that the relevant document is a related document).

The machine learning processing unit 32 uses the training data extracted by the training data extraction unit 46 to implement machine learning of the similarity score calculation unit 33. In the present embodiment, the machine learning processing unit 32 uses the training data (extracted documents) and the result of the determination as above to implement the machine learning of the similarity score calculation unit 33.

The similarity score calculation unit 33 is a processing unit capable of machine learning, and calculates the similarity score of each document of the training data extracted by the training data extraction unit 46.

This processing unit is a support-vector machine (SVM), a naive Bayes classifier, a random forest learner or a convolutional neural network, for instance, and the machine learning processing unit 32 employs a machine learning method corresponding to the type of this processing unit so as to implement the machine learning by using the training data and the like.

The retrieval condition input unit 22 specifies the reference document, which is desired by the user, and the population based on the user operation detected using the input device 3 and the display device 4 as a user interface, and designates the specified reference document and population toward the training data collection system 31.

The similarity score display unit 23 acquires similarity scores calculated by the similarity score calculation unit 33, sorts the documents, which have been extracted as training data, in descending order of the similarity score, and displays a combination of the documents and similarity scores of the documents as a list, for instance.

Next, operations of the systems as above are described.

Initially, the retrieval condition input unit 22 specifies a reference document desired by a user and a population based on a user operation, and designates the specified reference document and population toward the training data collection system 31.

In the training data collection system 31, the document acquisition unit 41 acquires the reference document, which is designated by the user, and a document belonging to the population.

Next, the morpheme analysis unit 42 extracts a morpheme of the reference document and a morpheme of a population document, and the vector generation unit 43 derives a feature vector of the reference document and a feature vector of the population document based on the morphemes.

Then, the feature quantity extraction unit 44 (a) performs a dimensionality reduction process to reduce dimensionality of the feature vector of the reference document and the feature vector of the population document and sets a value of one or more dimensions obtained by the dimensionality reduction process performed on the above feature vectors as a first feature quantity and (b) derives a cosine similarity between the feature vector of the reference document and the feature vector of the population document as a second feature quantity.

The retrieval range control unit 45 extracts a specific number of documents from the population in ascending order of the distance from a population document to the reference document in a feature quantity space of the first feature quantity, starting from the document with the shortest distance to the reference document, so as to limit a retrieval range. The training data extraction unit 46 extracts, as training data, a specific number of documents from among the documents, which have been extracted by the retrieval range control unit 45, in ascending order of the cosine similarity as the second feature quantity, starting from the document with the lowest cosine similarity.

In this way, training data as a non-related document is generated.

Further, the training data determination unit 47 allows the user to determine, for each document extracted by the training data extraction unit 46 as training data, whether the relevant document is a non-related document, so as to acquire the result of determination by the user.

The machine learning processing unit 32 uses the training data and the like to implement machine learning of the similarity score calculation unit 33.

The similarity score calculation unit 33 is a processing unit capable of machine learning and, after the machine learning implemented by the machine learning processing unit 32, calculates the similarity score of each document of the training data extracted by the training data extraction unit 46.

Similarity scores to the reference document of the respective documents in the population are thus calculated.

The similarity score display unit 23 acquires the calculated similarity scores, sorts the documents, which have been extracted as training data, in descending order of the similarity score, and displays a combination of the documents and similarity scores of the documents.

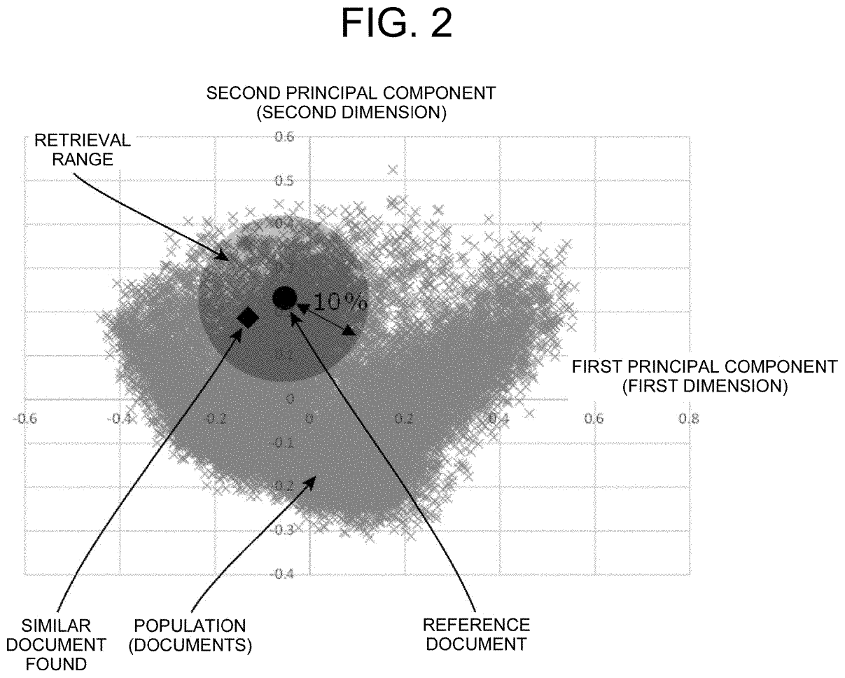

FIG. 2 is a diagram illustrating an example of the population, reference document, and retrieval range in the feature quantity space. In the example illustrated in FIG. 2, in a two-dimensional space constituted of two principal components as the first feature quantity, documents making up 10% of a population surrounding a reference document are extracted as a retrieval range. From the retrieval range, the training data is (non-related documents are) extracted so as to implement the machine learning and, after the machine learning, the similarity score of each document in the retrieval range is calculated and displayed. In this example, in the retrieval range extracted from the population, which includes 20 thousand documents, the document with the 38th highest similarity score was the desired document.

According to the embodiment as described above, the vector generation unit 43 derives a feature vector of a reference document and a feature vector of a population document. The feature quantity extraction unit 44 (a) performs a dimensionality reduction process to reduce dimensionality of the above feature vectors and sets a dimensional value obtained by the dimensionality reduction process performed on the feature vectors as a first feature quantity and (b) derives a cosine similarity between the feature vector of the reference document and the feature vector of the population document as a second feature quantity. The retrieval range control unit 45 extracts a specific number of documents from the population in ascending order of the distance from a population document to the reference document in a feature quantity space of the first feature quantity, starting from the document with the shortest distance to the reference document, so as to limit a retrieval range. The training data extraction unit 46 extracts, as training data, a specific number of documents from among the documents, which have been extracted by the retrieval range control unit 45, in ascending order of the cosine similarity, starting from the document with the lowest cosine similarity.

Therefore, machine learning is implemented so that a document with a lower conformation rate may have a lower similarity score, which makes it possible to carry out the document retrieval, in which documents with low conformation rates are hard to find and documents with high conformation rates (namely, correct documents) are only found easily.

It is evident to a person skilled in the art that the embodiment as described above can be subjected to various modifications and corrections. Such modifications and corrections may be made without departing from the gist and scope of the subject matter of the present disclosure and without reducing intended advantages. In other words, such modifications and corrections are intended to be incorporated in the claims.

For instance, the similar document retrieval program 2a in the above embodiment may be stored in a computer readable recording medium and installed from the recording medium into the storage 2.

The present disclosure is applicable to document retrieval, for instance.

What is claimed is:

1. A training data collection system comprising:
a vector generation unit that derives a feature vector of a reference document, and derives a feature vector of each document belonging to a population;
a feature quantity extraction unit that (a) performs a dimensionality reduction process to reduce dimensionality of the feature vectors and sets a dimensional value obtained by the dimensionality reduction process performed on the feature vectors as a first feature quantity and (b) derives a cosine similarity between the feature vector of the reference document and the feature vector of each document belonging to the population as a second feature quantity;
a retrieval range control unit that extracts a specific number of documents from the population in ascending order of a distance from a document belonging to the population to the reference document in a feature quantity space of the first feature quantity, starting from a document with a shortest distance to the reference document, so as to limit a retrieval range; and
a training data extraction unit that extracts, as training data, a specific number of documents from among the specific number of documents, which have been extracted by the retrieval range control unit, in ascending order of the cosine similarity, starting from a document with a lowest cosine similarity.

2. The training data collection system according to claim 1, further comprising a training data determination unit that allows a user to determine whether a document extracted by the training data extraction unit as the training data is a non-related document, acquires a result of the determination by the user, and includes the result into the training data.

3. A similarity score calculation system comprising:
the training data collection system according to claim 1;
a similarity score calculation unit that calculates a similarity score of a document of the training data; and
a machine learning processing unit that uses the training data to implement machine learning of the similarity score calculation unit.

4. A similar document retrieval system comprising:
the similarity score calculation system according to claim 3;
a retrieval condition input unit that designates the reference document; and
a similarity score display unit that sorts the documents extracted as the training data, in descending order of the similarity score and displays a combination of the documents and similarity scores of the documents.

5. A non-transitory computer readable recording medium storing a training data collection program that causes a computer to serve as:
a vector generation unit that derives a feature vector of a reference document, and derives a feature vector of each document belonging to a population;
a feature quantity extraction unit that (a) performs a dimensionality reduction process to reduce dimensionality of the feature vectors and sets a dimensional value obtained by the dimensionality reduction process performed on the feature vectors as a first feature quantity and (b) derives a cosine similarity between the feature vector of the reference document and the feature vector of each document belonging to the population as a second feature quantity;
a retrieval range control unit that extracts a specific number of documents from the population in ascending order of a distance from a document belonging to the population to the reference document in a feature quantity space of the first feature quantity, starting from a document with a shortest distance to the reference document, so as to limit a retrieval range; and
a training data extraction unit that extracts, as training data, a specific number of documents from among the specific number of documents, which have been extracted by the retrieval range control unit, in ascending order of the cosine similarity, starting from a document with a lowest cosine similarity.
